(19) United States
(12) Patent Application Publication
(10) Pub. No.: US 2011/0070862 A1
(43) Pub. Date: Mar. 24, 2011

(54) Method of Handling Paging and Related Communication Device

(76) Inventor: Te-Ming Chen, Taoyuan County (TW)

(21) Appl. No.: 12/882,228

(22) Filed: Sep. 15, 2010

Related U.S. Application Data
(60) Provisional application No. 61/244,453, filed on Sep. 22, 2009.

(51) Int. Cl. H04W 68/02; H04W 4/22

(52) U.S. Cl. 455/404.1; 455/458

(57) ABSTRACT

A method of handling paging for a mobile device in a wireless communication system is disclosed. The method includes the steps of receiving a paging message corresponding to an emergency call of the mobile device especially after the emergency call is released, wherein the paging message includes a field; and performing a radio resource control (RRC) connection establishment according to the field. Wherein, the field indicates whether the paging message is used for an emergency call.

### CROSS REFERENCE TO RELATED APPLICATIONS

This application claims the benefit of U.S. Provisional Application No. 61/244,453, filed on Sep. 22, 2009 and entitled “Methods of UE behaviours when access barred timer is running” the contents of which are incorporated herein.

### BACKGROUND OF THE INVENTION

1. Field of the Invention

A method used in a wireless communication system and related communication device are provided, and more particularly to, a method of handling paging in a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

In the LTE system, there is the need for a logical connection between the UE and the E-UTRAN. The logical connection provides a context for a particular network to UE communication link over which data may be transferred without miscommunication of the data to network elements or UEs in the system that are not intended to take part in the communication.

In the LTE system defined by 3GPP, the logical connection between the UE and the E-UTRAN is defined by radio resource control (RRC) connection states. The RRC connection states of the UE contain an RRC_IDLE state and an RRC_CONNECTED state. When the UE in the RRC_IDLE state attempts to setup an RRC connection with the E-UTRAN, the UE has to initiate an RRC establishment procedure and enters the RRC_CONNECTED state. The process of exchanging related RRC messages is described as follows. Firstly, the UE sends an RRC CONNECTION REQUEST message to the E-UTRAN. If the E-UTRAN accepts the request for connection establishment, the E-UTRAN sends an RRC CONNECTION SETUP message. Accordingly, the UE applies the related configuration setting according to the RRC CONNECTION SETUP message, and then sends back with an RRC CONNECTION SETUP COMPLETE message to notify the E-UTRAN that the related configuration setting is done. After the RRC connection establishment is complete, the UE enters the RRC_{—} CONNECTED state.

In addition, the RRC CONNECTION REQUEST message includes an RRC connection establishment cause. The eNB uses the RRC connection establishment cause to prioritize the RRC connection request from the UE, e.g. at high load situations. Currently, in the LTE system, the RRC connection establishment causes are defined as follows: an emergency call, high priority access, a Mobile Terminating (MT) call, Mobile Originating (MO) signaling and a MO call.

When being establishing the RRC connection for certain RRC connection establishment causes, the UE starts a timer, such as a timer T302, T303 or T305 and draws a random number “rand”, which is uniformly distributed in the range 0≦rand<1. A timer value T is a period of time that the UE has to wait for and given by: T=(0.7+0.6*rand)*access barring time. The access barring time is configured by E-UTRAN. When one of those timers is running, upper layers of the RRC layer of the UE are notified access barring for the MT calls, MO calls or MO originating signaling.

A user of an IMS network using a mobile device or any UE may place an emergency call, such as a 911 call (in North America) or a 112 call (in most of Europe). Such calls are typically handled by a Public Safety Answering Point (PSAP), which might coordinate an appropriate response to the emergency. After an emergency call is terminated, the PSAP may place a call back to the user for various reasons. For example, if the emergency call appears to have terminated abnormally, the PSAP might call the user back to determine if the user wishes to convey any additional information. Alternatively, the PSAP might call the user back to ask for information that was inadvertently not requested in the initial call. Other reasons for a call back from a PSAP to an emergency caller after the termination of an emergency call may be familiar to one of skill in the art.

The network shall support a call-back from the PSAP. It should be possible to supply the user's Directory Number/Mobile Station International Subscriber Directory Number (MSISDN)/Session Initiation Protocol (SIP) uniform resource identifiers (URIs) as the calling line identification (CLI) to the PSAP to facilitate call-back. The CLI used on call-back shall allow the PSAP to contact the same terminal that originated the emergency call. A call-back may be attempted anytime after the emergency call is released. The UE will perform the RRC connection establishment procedure with MT reason afterward. Namely, the emergency call back is considered a normal MT call. Nevertheless, in the situation of the timer T302 is still running, the UE cannot establish RRC connection between UE and network since the emergency call back is considered the MT call.

### SUMMARY OF THE INVENTION

A method of handling paging in a wireless communication system and related communication device are provided to successfully establish radio resource connection for an emergency call back.

A method of handling paging for a mobile device in a wireless communication system is disclosed. The method includes the steps of receiving a paging message corresponding to an emergency call of the mobile device after the emergency call is released, wherein the paging message includes a field; and performing a radio resource control (RRC) connection establishment according to the field. Wherein, the field indicates whether the paging message is used for an emergency call back.

A method of handling paging for a mobile device in a wireless communication system is disclosed. The method includes the steps of receiving a paging message corresponding to an emergency call of the mobile device after the emergency call is released; determining whether a field exists in the paging message; and performing a radio resource control (RRC) connection establishment according to a determination result.

A method of handling paging for a network in a wireless communication system is disclosed. The method includes the steps of including a field in a paging message corresponding to an emergency call of a mobile device after the emergency call is released; and sending the paging message to the mobile device for a radio resource control (RRC) connection establishment. Wherein, the field indicates whether the paging message is used for an emergency call back.

A communication device of handling paging in a wireless communication system is disclosed. The communication device includes means for receiving a paging message corresponding to an emergency call of the mobile device after the emergency call is released, wherein the paging message includes a field; and means for performing a radio resource control (RRC) connection establishment according to the field. Wherein, the field indicates whether the paging message is used for an emergency call back.

A communication device of handling paging in a wireless communication system is disclosed. The communication device includes means for receiving a paging message corresponding to an emergency call of the mobile device after the emergency call is released; means for determining whether a field exists in the paging message; and means for performing a radio resource control (RRC) connection establishment according to a determination result.

A communication device of handling paging in a wireless communication system is disclosed. The communication device includes means for including a field in a paging message corresponding to an emergency call of a mobile device after the emergency call is released; and means for sending the paging message to the mobile device for a radio resource control (RRC) connection establishment. Wherein, the field indicates whether the paging message is used for an emergency call back.

These and other objectives of the present disclosure will no doubt become obvious to those of ordinary skill in the art after reading the following detailed description of the preferred example that is illustrated in the various figures and drawings.

### BRIEF DESCRIPTION OF THE DRAWINGS

FIG. 1 illustrates a schematic diagram of an exemplary wireless communication system.

FIG. 2 illustrates a schematic diagram of an exemplary communication device.

FIGS. 3-5 are flow charts of an exemplary process.

### DETAILED DESCRIPTION

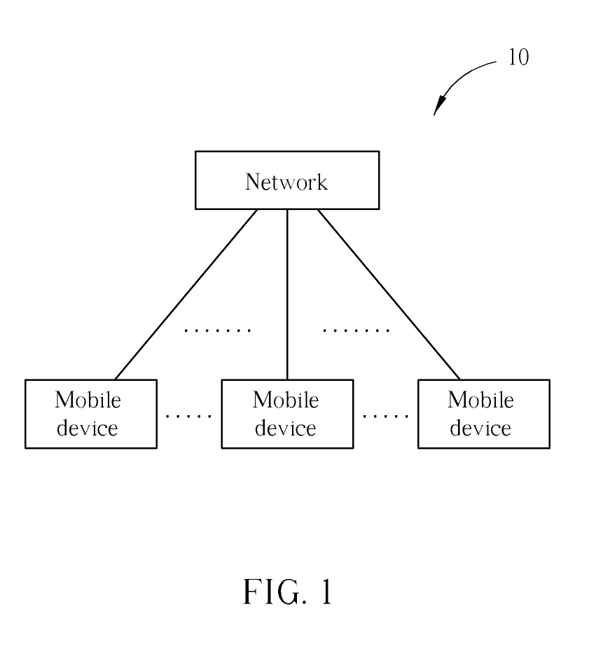

Please refer to FIG. 1, which is a schematic diagram of an exemplary wireless communication system 10. The wireless communication system 10, such as an LTE (long-term evolution) system or other mobile communication systems, is briefly composed of a network and a plurality of user equipments (UEs). In FIG. 1, the network and the UEs are simply utilized for illustrating the structure of the wireless communication system 10. Practically, the network comprising a plurality of base stations, such as an E-UTRAN (evolved-UTAN) comprising a plurality of evolved Node-Bs (eNBs) in the LTE system. The UEs can be devices such as mobile phones, computer systems, etc. Besides, the network and the UE can be seen as a transmitter or receiver according to transmission direction, e.g., for uplink, the UE is the transmitter and the network is the receiver, and for downlink, the network is the transmitter and the UE is the receiver.

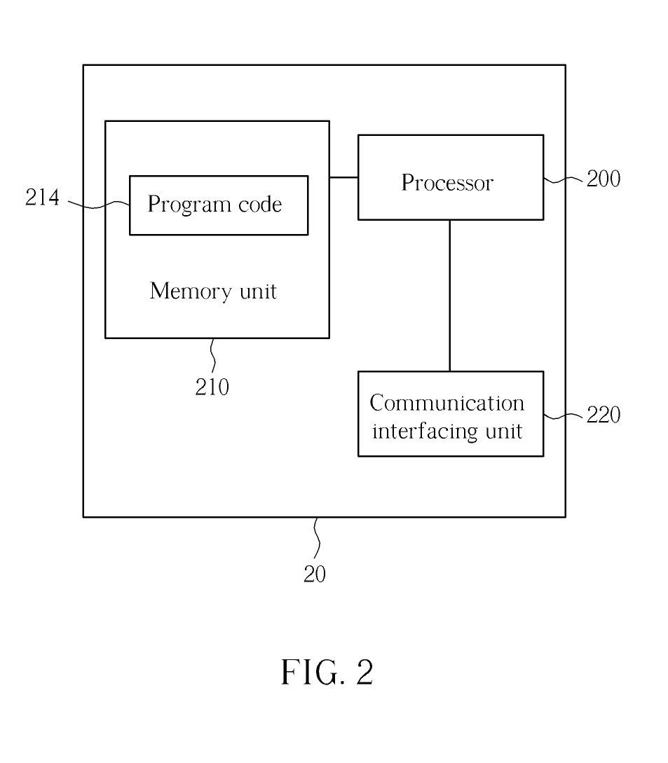

FIG. 2 is a schematic diagram of an exemplary communication device 20. The communication device 20 can be the UE shown in FIG. 1 and may include a processor 200 such as a microprocessor or ASIC, a memory unit 210, and a communication interfacing unit 220. The memory unit 210 may be any data storage device that can store program code 214, for access by the processor 200. Examples of the memory unit 210 include but are not limited to a subscriber identity module (SIM), read-only memory (ROM), random-access memory (RAM), CD-ROMs, magnetic tapes, hard disks, and optical data storage devices. The communication interfacing unit 220 is preferably a radio transceiver for wirelessly communicating with the network according to processing results of the processor 200.

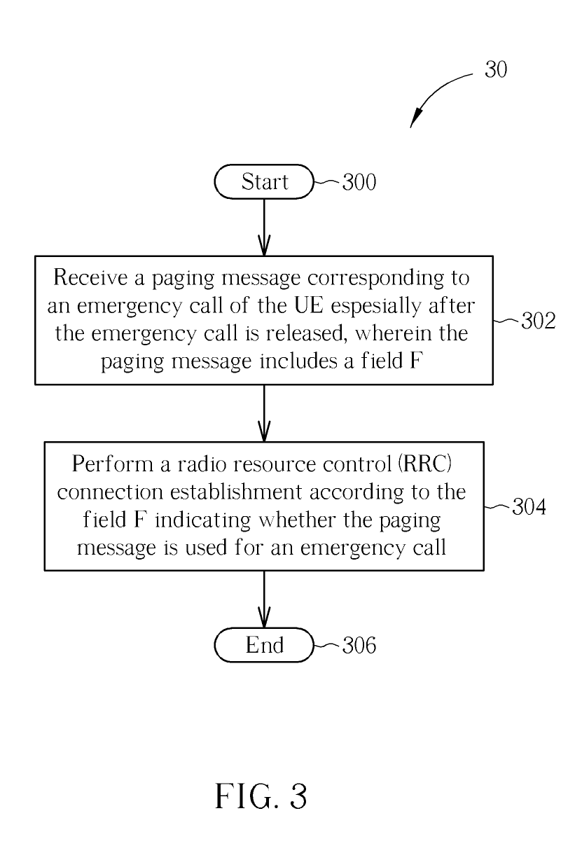

Please refer to FIG. 3, which is a flowchart of an exemplary process 30. The process 30 is utilized for handling paging for a UE in the wireless communication system 10 and can be compiled into the program code 214. The process 30 includes the following steps:

Step 300: Start.

Step 302: Receive a paging message corresponding to an emergency call of the UE especially after the emergency call is released, wherein the paging message includes a field F.

Step 304: Perform a radio resource control (RRC) connection establishment according to the field F indicating whether the paging message is used for an emergency call.

Step 306: End.

According to the process 30, the UE may receive the paging message corresponding to the emergency call of the UE especially after the emergency call is released. The emergency call may be released by UE itself, poor signals, or any unexpected conditions. The paging message is sent by a network, and includes the field F. The field F indicates whether the paging is used for the emergency call, e.g. an emergency call back or an emergency MT call, or the other reasons (e.g. normal mobile termination (MT) call). Then, the UE may perform the RRC connection establishment according to the field F. In other words, the field F is included in the paging message to indicate to the UE what purpose the paging message is used for. When the network sends the paging message to the UE for the emergency call, the UE receives the paging message and knows that the paging message is used for the emergency call by checking content of the field F. Then, the UE establishes an RRC connection for the emergency call. Compared with the prior art, the UE does not mistakenly consider the paging message is used for the normal MT call, which may cause RRC connection establishment failure. Instead, the UE establishes RRC connection for the emergency call based on the paging message, whether a timer T302 is running or not.

When the field F indicates that the paging message is used for the emergency call, the UE may perform the RRC connection establishment with an emergency establishment cause. When the field F indicates that the paging message is not used for the emergency call, the UE may perform the RRC connection establishment with a mobile termination (MT)-access establishment cause. The MT-access establishment cause and the emergency establishment cause are sent by the UE and included in a RRC message, such as a RRC Connection Request message. Briefly, the UE checks content of the field F included in the paging message and determines the cause (e.g. emergency establishment cause or MT-access establishment cause) for the RRC connection establishment.

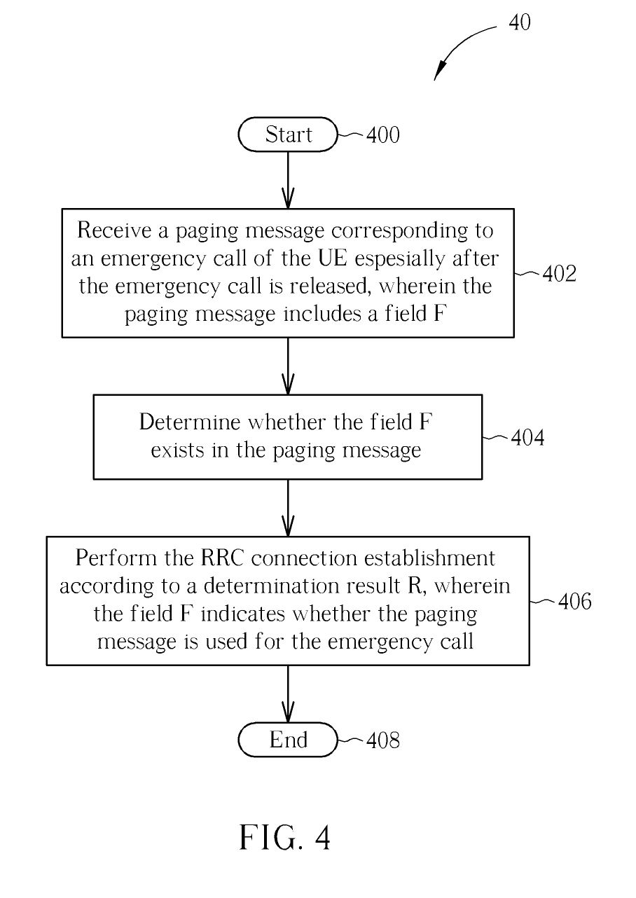

Please refer to FIG. 4, which is a flowchart of an exemplary process 40. The process 40 is utilized for handling paging for a UE in the wireless communication system 10 and can be compiled into the program code 214. The process 40 includes the following steps:

Step 400: Start.

Step 402: Receive a paging message corresponding to an emergency call of the UE especially after the emergency call is released, wherein the paging message includes a field F.

Step 404: Determine whether the field F exists in the paging message.

Step 406: Perform the RRC connection establishment according to a determination result R, wherein the field F indicates whether the paging message is used for the emergency call.

Step 408: End.

According to the process 40, the UE may receive the paging message corresponding to the emergency call of the UE especially after the emergency call is released. The emergency call may be released by UE itself, poor signals, or any unexpected conditions. The paging message is sent by a network. The UE may determine whether the field F exists in the paging message. When the determination result R shows that the field F does not exist in the paging message, it represents that the paging message is not used for the emergency call, e.g. an emergency MT call or an emergency call back. In this way, the paging message can be used for a normal MT call. When the determination result R shows that the field F exists in the paging message, it represents that the paging message is used for the emergency call. Briefly, the UE may know if the paging message is used for the emergency call or not, by checking existence of the field F. When the network sends the paging message to the UE for the emergency call, the UE receives the paging message and knows that the paging message is used for the emergency call by checking the existence of the field F. Then, the UE establishes RRC connection for the emergency call. Compared with the prior art, the UE does not mistakenly consider the paging message is used for the normal MT call, which may cause RRC connection establishment failure. Instead, the UE establishes RRC connection for the emergency call whether a timer T302 is running or not.

When the UE finds the field F in the paging message, the UE may perform the RRC connection establishment with an emergency establishment cause. When the UE does not find the field F in the paging message, the UE may perform the RRC connection establishment with a mobile termination (MT)-access establishment cause. The MT-access establishment cause and the emergency establishment cause are sent by the UE and included in a RRC message, such as a RRC Connection Request message.

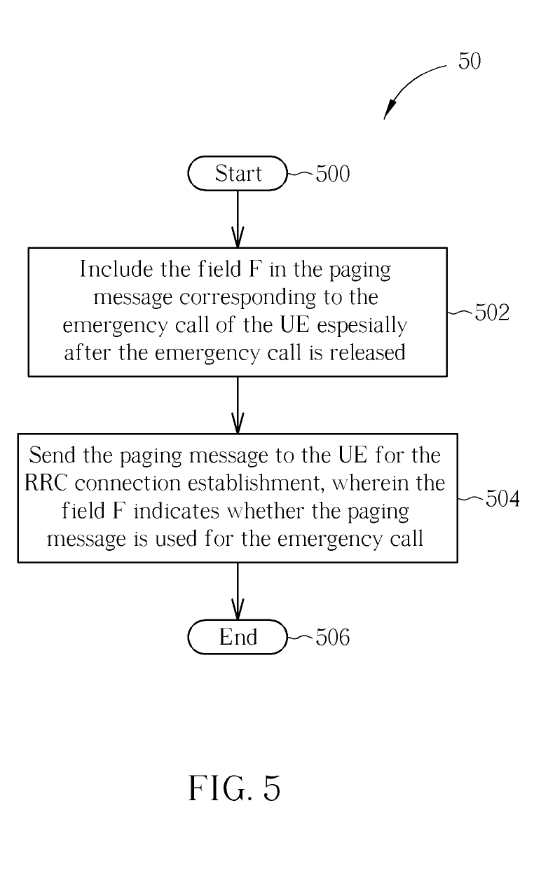

Please refer to FIG. 5, which is a flowchart of an exemplary process 50. The process 50 is utilized for handling paging for a network in the wireless communication system 10 and can be compiled into the program code 214. The process 50 includes the following steps:

Step 500: Start.

Step 502: Include the field F in the paging message corresponding to the emergency call of the UE especially after the emergency call is released

Step 504: Send the paging message to the UE for the RRC connection establishment, wherein the field F indicates whether the paging message is used for the emergency call.

Step 506: End.

According to the process 50, the network may include the field F in the paging message especially after the emergency call is released. Then, the network may send the paging message to the UE for the RRC connection establishment. Namely, the network indicates the purpose of the paging message by including the field F. When the paging is sent and received by the UE, the UE may perform the RRC connection establishment according to the field F. In some examples, different values may be assigned to the field F to indicate whether the paging message is used for the emergency call, e.g. an emergency MT call or an emergency call back, or the other reasons, e.g. an normal MT call. In some examples, the presence of the field F may represent the paging message is used for the emergency call, and the absence of the field F may represent the paging message is not used for the emergency call.

When the field F indicates that the paging message is used for the emergency call, the RRC connection establishment includes the emergency establishment cause. When the field F indicates that the paging message is not used for the emergency call, the RRC connection establishment includes the MT-access cause. The MT-access establishment cause and the emergency establishment cause are sent by the UE and included in a RRC message, such as a RRC Connection Request message.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processor 200 processes the program code 214 related to the abovementioned processes and the processed results can handle paging in the wireless communications system 20.

To sum up, when the emergency call is released, the network may send a paging message for an emergency call. According to the examples of the disclosure, the network includes a field in a paging message. The field can indicates to the UE whether the paging message is used for the emergency call when the UE receive the paging message. When the UE knows the paging message is used for the emergency call, the UE may send an emergency establishment cause in an RRC message (e.g. RRC connection request message) and perform RRC connection establishment for the emergency call. Thus, the RRC connection establishment will not fail due to the timer T302.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of handling paging for a mobile device in a wireless communication system, the method comprising:
receiving a paging message corresponding to an emergency call of the mobile device, wherein the paging message includes a field; and
performing a radio resource control (RRC) connection establishment according to the field;
wherein, the field indicates whether the paging message is used for an emergency call.

2. The method of claim 1, wherein performing the RRC connection establishment according to the field comprises performing the RRC connection establishment with an emergency establishment cause when the field indicates that the paging message is used for the emergency call.

3. The method of claim 1, wherein performing the RRC connection establishment according to the field comprises performing the RRC connection establishment with a mobile termination (MT)-access establishment cause when the field indicates that the paging message is not used for the emergency call.

4. A method of handling paging for a mobile device in a wireless communication system, the method comprising:
receiving a paging message corresponding to an emergency call of the mobile device; and
determining whether a field exists in the paging message; and
performing a radio resource control (RRC) connection establishment according to a determination result.

5. The method of claim 4, wherein performing the RRC connection establishment according to the determination result comprises:
performing the RRC connection establishment with an emergency establishment cause when the mobile device finds the field in the paging message; and
performing the RRC connection establishment with a mobile termination (MT)-access establishment cause when the mobile device does not find the field in the paging message.

6. A method of handling paging for a network in a wireless communication system, the method comprising:
including a field in a paging message corresponding to an emergency call of a mobile device; and
sending the paging message to the mobile device for a radio resource control (RRC) connection establishment;
wherein, the field indicates whether the paging message is used for an emergency call.

7. The method of claim 6, wherein the RRC connection establishment includes an emergency establishment cause when the field indicates the paging message is used for the emergency call.

8. The method of claim 6, wherein the RRC connection establishment includes a mobile termination (MT)-access cause when the field indicates the paging message is not used for the emergency call.
